(19) United States
(12) Patent Application Publication
(10) Pub. No.: US 2008/0277488 A1
(43) Pub. Date: Nov. 13, 2008

(54) Method for Controlling HVAC Systems

(76) Inventor: John F. Cockerill, Pleasantville, NY (US)

Correspondence Address: Lilling & Lilling PLLC, PO Box 435, Jerusalem, 91003, IL

(21) Appl. No.: 11/745,232

(22) Filed: May 7, 2007

(51) Int. Cl. F23N 5/20; G05D 23/30

(52) U.S. Cl. 236/46 R; 236/51

(57) ABSTRACT

The herein method for adjusting the source activation time of a heating or cooling source is based upon variation in temperature sensor or thermostatic means activity within a controlled environment, and involves activating and deactivating the heating or cooling source to provide precise heating or cooling BTU replacement. This method changes the priority of heating and cooling management from a fixed source output, which is called upon by a controlled environment thermostat, to a system of adjusting the source output to the precise delivery of source output to the needs of the enclosed environment at an ideal thermostat demand ratio within the controlled environment.

### BACKGROUND OF THE INVENTION

1. Field of the Invention

The invention relates to the commercial and residential construction and maintenance industries and, in particular, to devices for optimally controlling the activation of boilers, furnaces, ventilation units, humidifiers, fresh air handlers and air conditioning means.

2. Summary of the Prior Art

It is well known, all buildings, of what ever type, shape and size, whether commercial or residential, require some type of heating, ventilation and cooling. Depending on the particular building, there may be one or more boilers, furnaces, air conditioners, heat pumps, heat exchangers, ventilation units, humidifiers, dehumidifiers, solar units or similar means, hereinafter “sources”. Each is controlled by at least one sensor which may include programmable thermostats, controllers, control mechanisms, computers, control modules or the industry equivalents. Based on the temperature setting and the room temperature, the thermostat activates and deactivates a transfer medium output, as required. This activation and deactivation is referred to as demand activity. The transfer medium may be air, water, steam, glycol, refrigerant or other standard medium in the industry. Several patents refer to such systems.

Gauthier (U.S. Pat. No. 6,986,469) refers to reducing the fire time of the furnace or air conditioner based upon the change in temperature of controlled environment. Gauthier further transmits information on system usage and other characteristics to a system administrator. This system inherently requires the use of a digital control system to collect and store system data and requires the temperature control device to measure and transmit the temperature in the controlled environment.

Sigafus (U.S. Pat. No. 6,866,202) applies a thermostat algorithm to vary the fuel and fuel air mixture based on the recent activity of the temperature control device. This patent utilizes a series of specialized devices to vary the fuel or fuel air mixture including a variable speed compressor, a variable speed combustion (induced or forced draft) blower motor; a variable speed circulator blower motor; and a variable output gas valve or gas/air premix unit. This patent controls the fuel or fuel/air mixture, it does not adjust the fire time of the unit as a function of time.

Pouchak (U.S. Pat. No. 7,083,109) claims a system where in the modulating controls comprise PID (proportional, integral and derivative) control loop tuning. Further the system is controlled by set configurations. While the claimed system allows changes to a particular configuration those changes must be performed manually.

Levitin (U.S. Pat. No. 6,622,929) seeks to improve distribution of steam heat with the use of thermostat operated timer valves on individual zone or radiators. The described system does not utilize a function of time to control the boiler fire period.

Neve (U.S. Pat. No. 6,454,179) adjusts the boiler output by polling of the temperature set point satisfaction in a number of rooms. Boiler adjustments depend upon the number of rooms that are satisfied. This patent specifically seeks to activate the boiler for shorter periods more often. This is contrary to the present invention which seeks to activate the heating or cooling means for a period of time which is long enough to reduce losses inherent in starting the heating or cooling means but only long enough to transfer the required heat to or from the transfer medium to have the desired effect on the controlled environment.

Gilvat (U.S. Pat. No. 6,409,090) calculates an extended off time delay to re-fire a boiler in order to achieve energy conservation. This is accomplished by determining the energy transfer characteristics of the transfer medium and calculating a delay based on utilizing the heat contained in the transfer medium from a previous boiler fire to continue heating the controlled environment.

Hammer (U.S. Pat. No. 5,971,284) assumes that the heating or cooling unit should be interrupted when the temperature of the output reaches a steady state temperature. This is accomplished by measuring the temperature of the transfer medium at the output of the heating or cooling unit. This does not take into consideration the comfort of the occupants or the precise energy replacement needed. Further this may be difficult in applications where measuring the temperature of the transfer medium is not possible or the transfer medium does not undergo a temperature change.

Hammer (U.S. Pat. No. 5,960,639) relates the temperature output of the heating or cooling unit to the on call and off call times to calculate a delay to on state. This requires measurement of the temperature of the source medium which can be difficult particularly where temperature measurement is not possible or the transfer medium does not undergo a temperature change.

Kabat (U.S. Pat. No. 4,193,006) discloses a multi-stage controller which utilizes a condition control system where a counting means is used to provide for signaling additional demand. The described controller initiates additional stages of heating or cooling as opposed to adjusting the firing time of a heating or cooling unit.

Gottlieb (U.S. Pat. No. 4,433,810) describes a hot water heating system for a commercial building. It operates by monitoring the time that the pump is activated and controls water temperature accordingly, based on the theory that, if the pump is on longer, more water is required, and visa versa. For example, in the winter, if the pump is on frequently, then the water temperature of the furnace is made hotter. The issue with this device is monitoring the time the pump is activated does not accurately determine the required temperature of the pumped water. In fact this method may cause the water temperature to be increased unnecessarily, particularly, where for heating comfort it is desirable to maintain longer circulation time with lower temperature to maintain more even temperature distribution and to replace only the heat loss of the controlled environment.

Walker (U.S. Pat. No. 5,692,676) also discloses a device for adjusting the temperature of the boiler water, which is based on the off-time interval of the pump. If the thermostat is changed, this causes a corresponding change in pump activity. Since the temperature is being varied based on the off-time interval of the pump and not the ratio of the on/off time, an over correction will frequently be created.

McKinley (U.S. Pat. No. 4,844,335) uses a control system which senses the temperature external to the controlled environment, and also the water temperature of the boiler. Responsive to those two sensed values, it determines an upper temperature for the boiler at which the boiler is shut off. The control system further periodically determines the upper temperature for the boiler in accordance with the heating demands of the controlled environment.

Cargill (U.S. Pat. No. 4,381,075) also discloses a controller that monitors the temperature external to the controlled environment to adjust the heating or cooling unit's high limit. The controller operates so that the fluid side temperature is modulated by the operation of the burner as a function of the fluid side temperature and outdoor temperature and the circulating means is enabled to operate (whether or not the burner is ignited) as a function of the fluid side temperature and outdoor temperature to attain the indoor temperature as established by the thermostatic means.

Viessmann (U.S. Pat. No. 4,921,163) is based on the fundamental principle of carrying out a quasi-sliding control of the rated temperature of the heating or cooling unit in accordance with the outside temperature on the basis of data for the theoretical mean outside temperature on a specific calendar day. The rated temperature of the source is controlled time-proportionally or with a discretionary lead of hysteresis relative to a theoretical mean outside temperature, which is corrected additionally based on the time of the day and/or to other criteria.

Federspiel (U.S. Pat. No. 5,170,935) discloses comparison of a predicted thermal sensation rating to the actual thermal sensation rating of an occupant. The method measures selected environmental variables that affect thermal comfort in the enclosed area. Based on a formula the comfort index is calculated. The method does not particularly control the activation time of a heating or cooling unit.

Chaplin (U.S. Pat. No. 4,516,720) discloses an automatic temperature adjustment device which approximates an “ideal Reset” system by using a closed loop operation that automatically adjusts the operating parameter of a heating control system utilizing the reset principle. The objective of the invention is to minimize the standby heat losses of a heating system (e.g., hot water baseboard) by reducing the heating system fluid temperature to the lowest level possible with the current external ambient temperature. When the heating system is not on continuously, it adjusts the temperature of the fluid, so the system will be on continuously.

Cockerill (U.S. Pat. No. 6,402,043) describes a method for adjusting the temperature set point of a HVAC unit and activating and deactivating the HVAC unit utilizing a combination of sensors. One sensor is used to periodically determine the temperature or thermostat activity in a controlled environment and a second sensor is used to measure the temperature of a transfer medium output from said HVAC system. A microprocessor then receives stores and processes the information from the two sensors and is connected to a programmable controller to activate the HVAC unit. Based on the system demand as measured by the thermostat activity, the microprocessor determines a temperature set point for the HVAC unit. The HVAC unit is then activated, based on the deviation of the transfer medium temperature from the microprocessor calculated set point temperature for the HVAC unit.

The principal issue with the prior art is that all require extraneous temperature measurements, such as the temperature outside the controlled environment or the temperature of the transfer medium. The temperature outside the controlled environment is not indicative of the demand placed on the heating system, as wind sun exposure, occupant preferences, comfort control, building heat loss and gains, outdoor temperature and other factors further influence the demand. The temperature of the transfer medium, in certain applications, does not indicate the actual real time energy needs of the enclosed environment.

None of the prior art devices monitor the actual thermostat demand ratio over time and then compares it to the programmable ideal demand ratio to determine heating or cooling source adjustment of source activation cycle time. By recording thermostat activity at set intervals over a variably defined analysis time period, a more accurate model of the actual demand is created. If this is then compared to an ideal demand model, the system analysis can more precisely determine required changes to the source activation cycle times of the heating or cooling source.

Another disadvantage of some prior art is it seeks to gain efficiency in prolonged off time of the heating or cooling source and therefore reducing the number of starts for the heating or cooling unit. This is not necessarily efficient as each time the circulation pump stops, high temperature transfer medium looses energy to the walls of the pipes or duct in which it is housed. For many systems where the heating or cooling unit is located a considerable distance from the controlled environment, the energy is lost to the exterior environment and therefore is wasted. Then the next time the circulating pump starts, it must transport the transfer medium back to the heating and cooling unit to return the transfer medium to a useful state. On the other hand, the present invention seeks to maximize circulation of the transfer medium, thereby allowing more energy transfer to the controlled environment and thus reducing the energy lost to the exterior piping environment.

A further disadvantage of many of the prior art is that they generate transfer medium at a pre-set temperature and there is no variance, based on the actual room heat loss or gain characteristics. Steam boilers when activated operate on pressure sensors that are not sensitive to the changing conditions affecting heat loss or gain from the building. Specifically, when the heating or cooling system is installed or serviced, the system is set to generate transfer medium at a set temperature or pressure at the source. When the thermostat means activates the medium circulator pump or fan to cause a flow of transfer medium, it is not setting the temperature of the transfer medium. The air or water at the set temperature circulates into the room until the room air temperature returns to the thermostat setting (typically +/−2 degree) and then the thermostat deactivates the circulator. This causes further waste as there is retained heat in the transfer medium radiators which continues to be transferred to the controlled environment often causing an overshooting of the desired temperature.

In the winter, if it is a relatively warm day, or less then design degree day, the thermostat cannot adjust the boiler or furnace to produce less heating at the source. Instead, the furnace or boiler generates high limit temperature as would be generated on a very cold day, based on the preset temperature or pressure setting. In this condition the waste is created by short circulation cycles leaving the high limit medium in the transfer system to be wasted away into walls and non controlled environment. On less than design degree days, heating or cooling units run for a shorter time, as the demand is lower. Conversely, during cooling days, where heat needs to be removed, the air conditioner will blow cold air at the same temperature on a 75 degree day as on a 95 degree day. Further, short circulation periods do not allow even distribution of energy within the enclosed environment.

Conventional heating and cooling devices operate to maintain the temperature of the transfer medium within an assumed range in order to have effective energy transfer from the source to a controlled environment in the most demanding situation. Controls which compensate for outside temperature or by manual adjustments do not make a precise analysis of the heat loss or gain of an enclosed environment. The enclosed environment can have varying degrees of reaction to changes in the outer environment, as affected by wind, sunlight, building structure and occupant activity and preferences.

Since most heating or cooling means have manual pre-set settings for temperature or pressure, much system efficiency and comfort is lost. The building owner cannot adjust the source output, based on the building heat loss at a specific period of the day. Even if this could be accomplished, it would be inefficient to do so, as ambient temperature can change greatly during the course of a single day, sometimes by as much as 10-20 degrees Fahrenheit.

Therefore, with heating and cooling system efficiency becoming more important, it is desirable to create a device that permits continuous, efficient adjustment of the heating or cooling source unit output, as the heat gain and heat loss of the structure changes. Heat loss and gain are influenced by building structure heat loss characteristics, heating and cooling means design, solar gain, wind, occupancy behavior and preferences. By being able to adjust a heating or cooling unit with precise information from within the controlled environment, a more precise control of replacement energy to the controlled environment is achieved. Controlling the heating or cooling source unit activation time generates far more of an energy savings than the reduced time a circulator means may be on when building requirements are less than heating or cooling design conditions.

In some heating and cooling systems, the source unit is activated to create hot or cold air at a specified pre-set temperature. When the thermostat determines that room temperature has deviated too far from the set point, the circulation means is activated. The circulation means then moves the transfer medium at the fixed temperature range until the room temperature is restored, and then the thermostat deactivates the circulation means. Before, during and after use of the circulation means, the heating or cooling source unit may remain on to restore the transfer medium to a preset temperature. While the thermostat typically controls the circulator, the source unit may or may not be controlled by the thermostat. The source is usually set to generate sufficient heating or cooling during periods of extreme conditions, to avoid service calls for lack of meeting comfort requirements. Much of the heated or cooled transfer medium is left in the ducting or pipes at limit temperatures after the thermostat is satisfied. There are some applications where there is a delay in deactivating the circulation means after the heating or cooling unit has deactivated, thereby moving the transfer medium closer to the controlled environment. Often this is counterproductive as it may cause the system to overshoot the target temperature causing occupant discomfort and unnecessary correction of the thermostat setting by occupants.

These current methods are wasteful, and require a more responsive method to avoid producing too much heating or cooling than is required for comfort and efficiency. Systems operated using steam or fluids have the same disadvantages and inefficiencies.

### SUMMARY OF THE INVENTION

Therefore, in the industry there is a need for a simple method and device to more efficiently control the operation of sources and to utilize the generated transfer medium to and from the enclosed environment with precise end-use efficiency.

Thus, it is an object of the invention to provide a simple to use method that automatically adjusts the source activation time according to the ratio of the on time of the sensor, hereinafter “demand activity”, within an enclosed environment and also allows for a deactivation time break to allow for the conveyance of the source generated transfer medium to the controlled environment.

This is accomplished by periodically determining the sensor activity within the controlled environment at set intervals over a variably defined analysis time period. Then, an actual sensor demand ratio for the controlled environment is created from the data and compared to a programmable ideal demand ratio and a source activation time change factor is calculated. Then, the source activation time for the source is determined. In addition a programmable source deactivation time break is used in order for the transfer medium to continue to circulate, thereby allowing the cool or warm gas or liquid to be transferred to the controlled environment. In steam systems distribution is accomplished by steam travel in the system piping and condensing on cooler surfaces of radiation devices.

This method is accomplished by continually sampling the thermostat status in the controlled environment at fixed intervals over a variable defined analysis time period. The “on” status recordings are placed in comparison to the total recordings for a variably defined analysis time period and an actual thermostat demand ratio is established. These readings are then compared to a stored value for a programmable ideal thermostat demand ratio. Based on the difference between the actual thermostat demand ratio and the ideal thermostat demand ratio, the source activation time of the heating or cooling unit is increased or decreased for the next variable defined analysis time period.

A substantial improvement is obtained over the prior art, as such methods do not mimic the real nature of the gradual changes made within the controlled environment by the environment surrounding the controlled environment, which can vary from structure to structure and location to location. Demand activity can often change quickly due to opening/closing windows, cloud cover, wind, solar gain, occupancy behavior and preferences, thereby causing a corresponding on/off of the transfer medium circulation. Such a change may not require an actual change in the source activation time of the source unit.

Readings based on the actual thermostat behavior within the controlled environment over a variably defined analysis time period are inherently more suitable for human comfort as well as for accurate determination of heat loss or gain correction with precise supply of replacement energy. This is because thermostat changes and open/closed windows do not cause a false short term demand for heating or cooling unit output change. In a thermostat activity based system, unless environment characteristics cause a change in the demand over a period of time, they have little effect on the source activation time of the source. Such events do, however, result in variation in prior art systems, because such systems react based on the on/off cycle of circulation, which is immediately affected by open windows and changes in thermostat settings.

It is a further object of this invention to interpret thermostat activation over a variably defined analysis time period to reflect the real heat loss or gain characteristics of a controlled environment, as caused by heat loss or gain characteristics on a temperature controlled environment. This new method uses only measurements and readings from the existing sensor within the temperature controlled environment. This ability allows for precise source operation, and requires minimum alteration to the existing structure of the temperature controlled environment, thereby keeping the cost of a particular heating and cooling system modification to a minimum.

It is also an object to have a micro-controller instruct the source to provide the proper energy transfer medium to efficiently satisfy the controlled environment requirements, as prescribed by the controlled environment sensor requirements history.

It is another object of this invention to provide calculations according to a particular algorithm in order to change the source activation time in accordance with the actual changes in controlled environment demand activity over time. This aspect offers a broad application for the system to different environments. The reaction times may be adjusted to provide a smooth transition of energy supply in the same manner as can be expected by the heat loss or gains expected from the controlled environment. It removes the inherent delays between sources and the controlled environment which are caused by current methods in the field. In a heating application, higher circulation time of a generated transfer medium with a temperature of less variation from the controlled environment reduces the wasted piping or duct heat loss during periods of non circulation. Further, the use of warm rather than hot transfer medium with increased circulation avoids time delay in the reheating of the transfer medium and the conduits, which may be steam pipes, air ducts or hydronic transfer systems.

It is a further object of this invention to achieve economies in conservation of fuel and reduction of air pollution when demand is low and, on the other hand, greater response to periods requiring more capacity from the system by monitoring the source activation time of the heating or cooling system, and adjusting that source activation time to the precise comfort requirements of the temperature controlled environment. As the controlled environment demand analysis approaches ratios which indicate a greater or lesser need for change in source activation times, the micro-controller can change the source activation time of the heating or cooling system proportionally to supply higher or lower temperature energy transfer medium.

It is a further object of this invention to enable the control of modulating boilers by production of variable voltage outputs when required for such modulating equipment.

It is a further object of this invention that the resulting reduction in fuel use will proportionally reduce the amount of exhaust gases and there related pollutants released to the atmosphere.

### BRIEF DESCRIPTION OF THE SEVERAL VIEWS OF THE DRAWINGS

FIG. 1 is a block diagram of the active components of the device for adjusting the source activation times of a heating or cooling unit and also turning it on and off; and

FIGS. 2a and 2b are flow charts showing the operational steps of the herein method for adjusting the source activation times of a heating or cooling means and also turning it on and off.

### DETAILED DESCRIPTION OF THE INVENTION

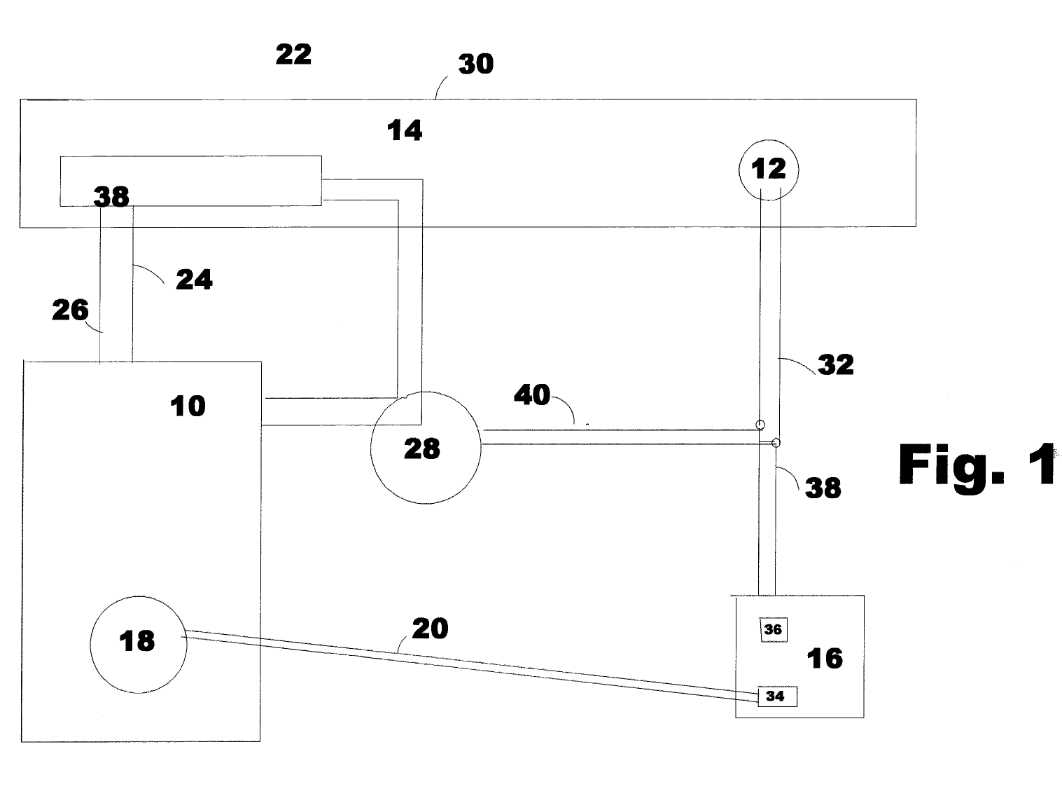

As shown in FIG. 1, a heating, cooling or ventilation system 10 is used to satisfy the heating, cooling or ventilation needs of a controlled environment 14, such as a house or office building or just a single room. A liquid or gas transfer medium 24, such as air, steam, gas or fluid, may be utilized. As a preferred embodiment, reference will be made to a system for controlling the temperature in a controlled environment. However, the control system of the present invention may be utilized for efficient control of a variety of equipment utilizing a circulating transfer medium to effect a change in a controlled environment. Such other systems may include air filtration, humidification or dehumidification systems.

The actual temperature in the controlled environment 14 is determined by the BTU exchanged (heat lost or gained) with the exterior environment 22 and the BTUs added or removed by a heating or cooling system 10. The exterior environment 22 may be any space outside the outer walls 30 of the controlled environment 14. The outside environment 22 could be another room, the out of doors atmosphere, or another controlled environment different from the controlled environment 14. Generally, the controlled environment 14 is a closed area which requires a maintained temperature, humidity or air quality for preservation or comfort of contents and/or of the occupants utilizing the environment.

A sensor 12 may be a thermostat or other sensing device used to request circulation of a transfer medium from circulation pump 28 over circuit cables 32 and 40 via micro-controller 16 and receiver sensor 36 to maintain a proscribed attribute within the controlled environment 14. The sensor 12 can be any of several types of temperature sensors or thermostat means for temperature, humidistat for humidity, air quality sensor or other any other device for the detection of deviations from set standards in a controlled environment 14 provided it meets the accuracy and reliability of the incorporated system.

A source 18 within the system 10 is used to generate transfer medium 24 and can be any device which is used in buildings for the modification of the temperature, air quality or humidity, such as an oil or gas burner, heat pump, solar generator, electric element, thermal storage device, a subsystem of a larger heating source, geothermal heat exchange, steam boiler, hot water boiler, air conditioning compressor, dehumidifier, humidifier or filtration device.

A transfer medium circulator 28 can be any pump, fan, mixing valve, steam zone valve, zone valve, zone control system, steam piping or similar device which will move the transfer medium 24 from source 18 through a medium transfer duct 26 to an exchanger 38, such as conventional air ducts within a standard floor, wall and/or ceiling or positioned vents or radiators, within the temperature controlled environment 14.

Micro-controller 16 processes the information from the sensor 12 in controlled environment 14 over cables 32 and 38 and then determines the source activation time for the source 18.

A disconnect relay 34 is used via cable 20 to deactivate source 18 of the system 10, when source requirements are satisfied.

During operation, the controlled environment sensor 12 is used to control the activation of the transfer medium circulator means 28 and provide demand status over a variable defined analysis time period and to store this information in the micro-controller 16, so that a history of periodic readings of actual activation status within the controlled environment 14 is available for analysis. For temperature the heat lost or gained by the controlled environment 14 will determined the activity of the sensor 12 where the number of “on” readings indicating demand for heat is compared to the total number of readings. Sensor 12 may also be configured to initiate source activation.

In turn, the micro-controller 16 utilizes the data from the controlled environment sensor 12 to determine the required source activation time needed to satisfy the needs of the controlled environment 14. The micro-controller 16 controls the activation of the source 18. The sensor 12 controls activation of transfer medium circulator 28 to move the transfer medium 24 from system 10 to transfer medium exchangers 38 within the controlled environment 14.

As controlled environment 14 is modified by the transfer medium in exchangers 38, the controlled environment sensor 12 will either establish that the desired comfort has been obtained or it will continue to generate signals to the transfer medium circulator 28, based upon the influence of outside environment 22 and other loss and gain influences. For a heating system where the desired temperature has not been met the sensor 12 would continue to indicate a need for circulation of heated transfer medium by the transfer medium circulator 28, or in the case of steam to the steam zone control valve, these readings would be interpreted as an “on” status by the micro-controller 16. The same activity would apply for cooling in the case of a heat gain in summertime.

A continuing analysis by the micro-controller 16 of the sensor 12 at intervals over time will yield an actual demand activity of “on” status recordings over the total number of periodic demand status recordings. These readings may be made at any interval. The actual demand activity is compared to a user programmable ideal demand ratio. The result is a source activation time change factor. This factor is modified from a percentage to a number greater than 1 by multiplication by 10. It is further modified by multiplication by a user programmable time factor. Both the ideal demand ratio and the time factor are set by an installer and are based on experience with a particular system and the environmental variables of the structure. This yields a source activation time change factor which yields the change in time of the source activation time from the previous variable defined analysis time period. Should the actual demand ratio be above the ideal thermostat demand ratio, the micro-controller will increase the source activation time of source 18, thereby raising the energy in transfer medium 24 and consequently providing increased energy to controlled environment 14. If the source activation time change factor should be negative, the micro-controller will decrease the source activation time lowering the transfer medium 24 energy supply.

It is the successive progress of analysis and adjustment which creates the gradual adjustment of gain or loss within controlled environment 14. In a typical building with human occupants the defined variable analysis time period could be set for 60 minutes and the typical adjustment, when needed in the source activation time, could be a part of a minute or up to several minutes. If the analysis of change shows a more severe need due to a higher source activation time change factor, the adjustment could be several minutes. Each variable is programmable within the micro-controller, and can be adjusted as required by the system operator. Since the programmable variables are set to the needs of the controlled environment 14, the settings can be permanent until such time as the specifications for the controlled environment 14 change.

The process is continuous in that the micro-controller 16 analysis of the requirements of the temperature controlled environment 14 and the activation of the source 18 is ongoing. The micro-controller's control over the source 18 is simultaneous and independent from the sensor's 12 control and activation of the transfer medium circulator 28.

In a heating situation micro-controller 16 will activate the heating source 18 when activation is called for by software calculations. Heating source 18 will be deactivated to commence a programmable deactivation time break 76 at the end of the source activation time 74 or at a point when the sensor 12 indicates satisfaction of demand 72. The deactivation break 76 will take priority over activation by sensor 12 of the heating source 18 until the deactivation time break is expired. However, deactivation break 76 will not affect the control of sensor 12 over the transfer medium circulator 28, thus the transfer medium circulator 28 may be on during the deactivation break of the heating source 18. At the end of the deactivation time break 76, activity of the sensor 12 will initiate the source activation time and activation of the heating source 18.

By this process the controlled environment 14 is maintained at required comfort levels with minimum expense of energy and minimum temperature variation within the controlled environment 14. During periods of analysis and between source activation time adjustments, the controlled environment sensor 12 sends demand status signals activating the transfer medium circulator 28 as well as providing periodic status data for micro-controller 16.

The continuous operation of the complete system becomes a relationship between actual thermostat demand ratio, ideal thermostat ratio and the changes in requirements for source activation times. Continuous readings of sensor 12 allows for the activation of the source 18 to provide precise energy recovery for temperature controlled environment 14.

A further embodiment or use of this invention is the control of cooling plants for refrigeration and air conditioning applications. In a similar operation as heating applications, the system can moderate the source activation time of cooling medium, thereby avoiding wasteful over cooling and under cooling conditions. By supplying a more precise controlled transfer medium, there is a resulting conservation in electricity used to cool controlled environment 14. With the addition of operating relays to perform the air conditioning reduction, the micro-controller can monitor the readings of the controlled environment sensor 12 and generate analogous signals for the cooling system as it did for the heating system.

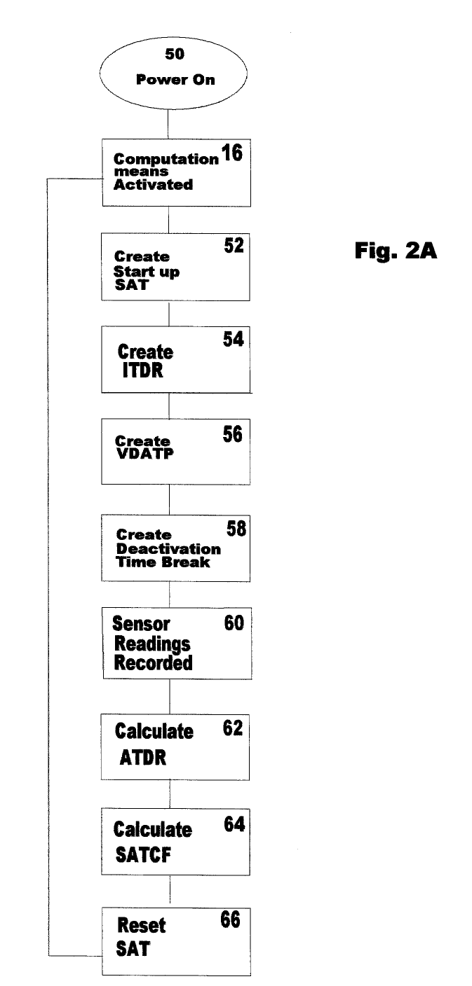

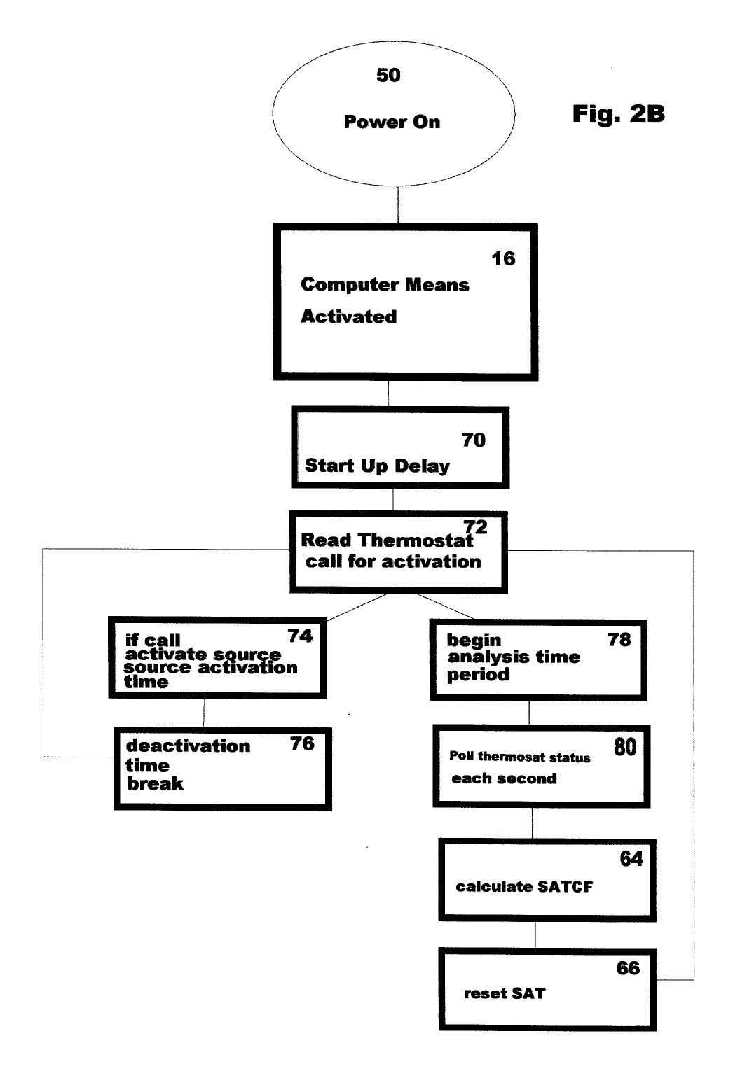

In the preferred embodiment, the method of controlling the source activation time of the source 18 is affected according to the process shown in the flowcharts of FIGS. 2a and 2b. All variables are programmable to the particular installation and controlled environment design.

Necessarily the power is first switched on 50 and the micro-controller 16 is activated. It may be appreciated that the method herein is actually two separate procedures, but each may be used independently of the other. FIG. 2a shows the flowchart for the micro-controller procedure for optimizing the adjustment of the source activation time of the heating or cooling means, and FIG. 2b shows the flowchart for the micro-controller procedure for turning the heating or cooling means on and off. Typically, both procedures are running together at the same time to optimize the efficiency of the system.

Turning now to the flowchart of FIG. 2a, the above procedure for monitoring demand and determining the source activation time is illustrated. The micro-controller starts up with a programmable source activation time (SAT) 52. The ideal thermostat demand ratio (ITDR) for the particular temperature controlled environment is programmed 54 and loaded into the micro-controller. Various parameters are considered, such as climate, season, cloud cover, wind, exposure, intended use of environment (office, storage, residential, equipment, computer systems, etc), and the operator determines the ideal demand ratio.

Next, the micro-controller 16 is programmed to take periodic readings of the sensor 12 over a variable defined analysis time period 56. The defined variable analysis time period will be determined by the system operator, depending on the particular heating or cooling means and the nature of the controlled environment. It is generally appropriate to use a variable defined analysis time period (VDATP) 56 of between 15 and 180 minutes for most residential and small commercial systems, however, it may be any period of time which will provide a proper analysis by the micro-controller. This time period generally provides enough, of a sample for effective adjustment of source activation time (SAT) 66. A variable defined analysis time period for status polling must be set by the operator into the micro-controller 56.

At 52 a programmable start up source activation time is established which is activated at the first activation after delay. After the variable defined analysis time period, the micro-controller 16 will process the data obtained from the thermostat 60 and calculate the actual thermostat demand ratio (ATDR) 62. This ratio is equal to the total number of “on” status recordings of the sensor 12 divided by the total number of status recordings:

ATDR=Total activation “on” status recordings/Total number of status recordings

Thereafter, the source activation time change factor (SATCF) 64 is calculated as:

SATCF=ATDR−ITDR*10

Not only is the actual value of SATCF important, but also the sign of the temperature change factor. A heating application with a negative source activation time change factor indicates the controlled environment is too hot and the source activation time will be reduced. Conversely, a positive source activation time change factor indicates the environment is too cold, and the source activation time will be increased.

The microprocessor then calculates the source activation time (SAT) 66,

SAT=(SATCF)*(X minutes)+current source activation time

SATCF is multiplied by a time variable, which depends on the particular heating or cooling unit. It is generally appropriate to use 1-10 minutes, but may be any appropriate period for the installation. Thus SATCF is first converted to a number greater than one, then into minutes and acts as an adjustment to the source activation time for the heating or cooling unit. The micro-controller 16 through cables 20 activates the heating or cooling unit 18 for the source activation time 66.

By this means in the preferred embodiment, the source activation time is adjusted for the most efficient operation of the source 18.

After completion of this setting of the source activation time, the process is repeated continually utilizing the immediately prior analysis period until the micro-controller 16 is reprogrammed or deactivated. As desired, the micro-controller 16 can continually sample over the analysis time periods indefinitely, or may be reprogrammed for a different variable defined analysis time period. This permits the micro-controller 16 to continually maintain the most efficient source activation time for the source 18 to provide for comfortable end-use system efficiency.

Reference is now made to FIG. 2b and the flow chart for micro-controller control of the heating or cooling unit 18. Again, the micro-controller 16 is first turned on 50 and the micro-controller 16 is activated. Frequently, there may be a delay 70 before the micro-controller 16 starts. This delay serves to avoid damage to the heating or cooling unit 18 due to electrical surge after power outage.

The micro-controller 16 is connected to the source 18 at relay 34. Upon “on” status activation from a sensor 12, relay 34 is activated for an initial programmable start up or reset source activation time 74 followed by a programmable deactivation time break 76 or by an “off” status from sensor 12. If after the deactivation time break 76 the thermostat 72 is still signaling an “on” status, the micro-controller would allow relay 34 to close and activate the source 18 for the source activation period 74 followed by a deactivation time break 76. This cycle of operation would continue until the sensor 12 indicated being satisfied with an “off” status. This action would commence another deactivation time break 76. Should the sensor 12 signal an “on” status recording, source 18 would not be activated until the deactivation time break is completed 76. The continued “on” status recording would then allow the source 18 to activate for a new complete cycle of source activation time 74 followed by a deactivation time break 76. The interchange between the process above allows for smooth replacement of heat loss or heat gain to the controlled environment 14 together with the avoidance of over supply of heat gain or cooling due to system delivery delays inherent to heating and cooling systems where the sensor 12 is considerably separated from the source 18.

The method for adjusting the source activation time 74 of a source 18 based upon the sensor 12 activity and activating and deactivating the source 18, utilizes one or more sensors 12 to periodically determine the system demand in a controlled environment 14. A micro-controller 16 receives stores and processes information from the sensor 12 and is connected to and controls the source 18. The sensor 12 activation status for the controlled environment is recorded at set intervals over a variably defined analysis time period and status recordings are stored in the computational means 16. An actual thermostat demand ratio for the controlled environment 14 is created by the micro-controller 16, based on the status recordings. By dividing the “on” status recordings by the total status recordings, during the analysis period, the actual demand ratio is calculated within the micro-controller 16.

A programmable ideal demand ratio is defined as the preferred rate of “on” status activity desired at the sensor compared to the total activity. The actual demand activity is compared to a programmable ideal demand ratio and a source activation time change factor is calculated. The result is multiplied by 10 in order to achieve a value greater than one. The result is then multiplied by a programmable time factor. Source activation time for the source is determined, based upon the source activation time change factor. The micro-controller then adjusts the source activation time of the source for the duration of the next variable defined analysis time period. In addition, the micro-controller continuously monitors the accumulating activation time of the source. This accumulating activation time is compared to the source activation time. The micro-controller then generates a signal to the source for deactivation when the set source activation time has expired. The source is turned off by the micro-controller when the accumulated activation time equals the source activation time or when the sensor requirement is satisfied. The micro-controller then commences a programmed deactivation time break which is a programmable variable of time or a time period proportional to the source activation. It is preferred that the programmable deactivation time break or a proportional deactivation time break be great enough to allow for the satisfaction of the sensor in the controlled environment during said deactivation time break in less than demanding operational conditions. Under these conditions the source will remain “off” until the sensor indicates another demand period. During periods of extreme change in environmental demand or system start up may require several cycles through the deactivation time break before the satisfaction of the controlled environment demand is met. The source activation time and the deactivation time break cycles will continue until the satisfaction of the sensor. At the end of the variable defined analysis time period, the micro-controller will recalculate the source activation time based upon the actual thermostat demand calculation.

In this manner, the micro-controller can better control the on/off activation of the source 18, so it corresponds better to the actual loss or gain in the controlled environment 14.

The invention is described in detail with reference to a particular embodiment, but it should be understood that various other modifications can be effected and still be within the spirit and scope of the invention.

I claim:

1. A method for controlling the activation and deactivation time of a HVAC source for a controlled environment, comprising the steps of:
setting a programmable ideal demand ratio for said controlled environment;
recording the activation status of a sensor in said controlled environment at set intervals over a programmable analysis time period by counting the number of “on” status readings of said sensor;
at the conclusion of said programmable analysis time period,
calculating an actual demand ratio for said controlled environment by comparing said recorded activation “on” status to a total number of status readings over said programmable analysis time period;
comparing said actual demand ratio to said programmable ideal demand ratio and calculating a source activation time change factor;
calculating a new source activation time for said source, based on said source activation time change factor; and
adjusting the previous source activation time for said source to said new source activation time for the following said variable defined analysis time period;
continuously monitoring activation time of said source;
comparing said activation time to said source activation time;
activating said source when said sensor is activated;
deactivating said source when said source activation time is expired or when said sensor is deactivated; and
continuing said deactivation for a fixed or calculated deactivation time break.

2. A method according to claim 1, wherein there are 3600 set intervals to read the status of said sensor and the programmable analysis time period is one hour.

3. A method according to claim 1, wherein said source activation time change factor is equal to said actual demand ratio minus said programmable ideal demand ratio multiplied times ten to achieve an positive value, and said source activation time for said source being equal to a programmable time variable multiplied by said source activation time change factor, plus a source activation time from the previous said variable defined analysis time period, wherein a positive said source activation time change factor indicates a need for increase in said source activation time and a negative said source activation time change factor indicates a need for decrease in said source activation time.

4. A method for controlling the activation of a HVAC source for a controlled environment, utilizing a sensor and a micro-controller receiving, storing and processing information from said sensor and connected to and controlling said HVAC source, wherein the improvement comprises controlling the activation and deactivation time of said source, comprising the steps of:
setting a programmable ideal demand ratio for said controlled environment and storing said programmable ideal demand ratio in said micro-controller;
recording periodic sensor “on” status recordings for said controlled environment for a programmable analysis time period and storing data in said micro-controller;
at the conclusion of said programmable analysis time period,
creating an actual demand ratio for said controlled environment by comparing said sensor status “on” recordings to the total status recordings during the variable defined analysis time period and storing said actual demand ratio in said micro-controller;
comparing said actual demand ratio to said programmable ideal demand ratio and determining an activation time change factor by means of said micro-controller;
calculating a source activation time for said source, based on said source activation time change factor, by means of said micro-controller; and
generating a signal from said micro-controller to activate said source for said source activation time;
continuously monitoring activation time of said source utilizing a rolling time period and storing a new activation time in said micro-controller;
comparing said new activation time to said source activation time by means of said micro-controller;
generating a signal from said micro-controller to said source for deactivating said source when said source activation time has elapsed or said sensor is not in an “on” state; and
providing for a deactivation time break to allow transfer medium circulation means to balance thermal production with thermal loss or thermal gain at said sensor or thermostat means.

5. A method according to claim 1, wherein there are 3600 set intervals to read the status of said sensor and the programmable analysis time period is one hour.

6. A method according to claim 4, wherein said source activation time change factor is equal to said actual demand ratio minus said programmable ideal demand ratio multiplied times ten to achieve an Integer value, and said source activation time for said source being equal to a programmable time variable multiplied by said source activation time change factor, plus a source activation time from the previous said variable defined analysis time period, wherein a positive said source activation time change factor indicates a need for increase in said source activation time and a negative said source activation time change factor indicates a need for decrease in said source activation time.

7. A device for adjusting source activation time of a HVAC source for a controlled environment and activating and deactivating said source comprising: a sensor; and a micro-controller connected to and receiving, storing and processing information from said sensor; wherein said micro-controller
is connected to and controls said HVAC source;
stores a programmable ideal demand ratio for said controlled environment;
stores a programmable analysis time period;
creates an actual demand ratio from said controlled environment, based upon “on” status recordings from said sensor, divided by a total of said status recordings at the conclusion of said programmable analysis time period;
compares said actual demand ratio to said ideal demand ratio multiplied times ten to achieve an integer establishing a source activation time change factor;
calculates a new source activation time for said source, based on said source activation time change factor, multiplied by said programmable time variable;
adjusts the new source activation time of said source for the next programmable analysis time period;
continuously monitors the actual activation time of said source since the start of the current programmable analysis time period and stores said value as the accumulated activation time;
compares said accumulated activation time of said source to said source activation time, deactivating said source when said accumulated activation time is equal to or greater then said source activation time;
activates said source when said sensor indicates an “on” status;
deactivates said source when said sensor does not indicate an “on” status; and
deactivates said source for a deactivation time break at the end of said source activation time or upon status from said sensor indicating not “on”, whichever occurs first, commencing said deactivation time break.

8. A method according to claim 7, wherein there are 3600 set intervals to read the status of said sensor and the programmable analysis time period is one hour.
